(19) United States
(12) Patent Application Publication
(10) Pub. No.: US 2008/0137967 A1
(43) Pub. Date: Jun. 12, 2008

(54) EDITING APPARATUS, DESIGN EDITING METHOD, AND STORAGE MEDIUM THEREFOR

(75) Inventor: Noriyuki Yamamoto, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/926,970

(22) Filed: Oct. 29, 2007

(30) Foreign Application Priority Data
Dec. 7, 2006 (JP) 2006-330687

(51) Int. Cl. G06K 9/74

(52) U.S. Cl. 382/214

(57) ABSTRACT

An apparatus includes a reference point setting unit configured to set a reference point on an image to be fitted into a layout frame of a template, a trimming unit configured to perform trimming processing on the image according to the reference point being set on the image and an aspect ratio of the layout frame, and a layout unit configured to fit the trimmed image into the layout frame.

### BACKGROUND OF THE INVENTION

1. Field of the Invention

The present invention relates to an apparatus capable of processing an image displayed on a display screen for inserting into a layout frame, an image editing method, and a storage medium therefor.

2. Description of the Related Art

The recent role of computers includes generating various designs with a layout of images. An exemplary computer-aided design generation method includes fitting an arbitrary image into a frame of a template and generating a design including the fitted image. In the following description, the frame of a template into which an image can be fitted is referred to as “layout frame.” The above-described method further includes, if an aspect ratio of an image to be fitted is different from an aspect ratio of a layout frame of the template, trimming the image according to the aspect ratio of the layout frame.

As discussed in Japanese Patent No. 2917781, in the processing for trimming an image, a user designates a rectangular trimming region on an image so that an essential part of the image can be completely involved in a selected layout frame.

However, it may not be easy for a user to determine a template to be used if numerous templates are available. In this case, an exemplary method includes automatically selecting an appropriate template, if a user selects an image to be fitted, and presenting the selected template to the user. Furthermore, the exemplary method includes enabling a user to set a rectangular region designating a “trimming area” into which a selected image can be fitted and displaying an enlarged or contracted “trimming area” that is inscribed in a selected layout frame.

According to this method, if an aspect ratio of a layout frame of each template is unknown to a user, the user may set a “trimming area” having an aspect ratio greatly different from the aspect ratio of the layout frame. Furthermore, when the “trimming area” is set in the vicinity of an image edge region (especially, four corners), an edge region of an image may be involved in the layout frame and the layout frame may include an area where no image is present.

### SUMMARY OF THE INVENTION

Exemplary embodiments of the present invention are directed to an apparatus (e.g. design editing apparatus) that can easily set a reference point that determines a trimming area, in fitting an image into a layout frame, and can determine the trimming area according to an aspect ratio of the layout frame and the reference point being set on the image. Furthermore, the exemplary embodiments of the present invention are directed to a method and a storage medium relating to the design editing apparatus.

According to an aspect of the present invention, an apparatus includes a reference point setting unit configured to set a reference point on an image to be fitted into a layout frame of a template, a trimming unit configured to perform trimming processing on the image according to the reference point being set on the image and an aspect ratio of the layout frame, and a layout unit configured to fit the trimmed image into the layout frame.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 is a block diagram illustrating a design editing apparatus according to an exemplary embodiment of the present invention.

FIG. 2 is a flowchart illustrating an exemplary operation of the design editing apparatus illustrated in FIG. 1 which can fit an original image into a template.

FIG. 3 illustrates a reference point setting screen that displays an original image and enables a user to set a reference point.

FIG. 4 illustrates a template and a design editing screen that can determine the basic layout of a design.

FIG. 5 illustrates a layout frame of the template into which a selected original image can be fitted.

FIG. 6 illustrates a trimming area determined based on an aspect ratio of a selected layout frame with reference to a trimming reference point.

FIG. 7 illustrates an edited template that can be obtained by fitting a trimmed image into a selected layout frame of the template, displayed in a design display area of the design editing screen.

FIG. 8 illustrates an exemplary layout of original images fitted into layout frames according to an arbitrary order in a case where the number of the original images is identical to the number of the layout frames.

FIG. 9 illustrates an original image list screen that displays a list of plural original images.

FIG. 10 illustrates the original image list screen that does not display reference points.

FIG. 11 illustrates an enlarged display of an original image in the original image list screen illustrated in FIG. 9.

### DETAILED DESCRIPTION OF THE EMBODIMENTS

The following description of exemplary embodiments is illustrative in nature and is in no way intended to limit the invention, its application, or uses. Processes, techniques, apparatus, and systems as known by one of ordinary skill in the art are intended to be part of the enabling description where appropriate. It is noted that throughout the specification, similar reference numerals and letters refer to similar items in the following figures, and thus once an item is described in one figure, it may not be discussed for following figures. Exemplary embodiments will be described in detail below with reference to the drawings.

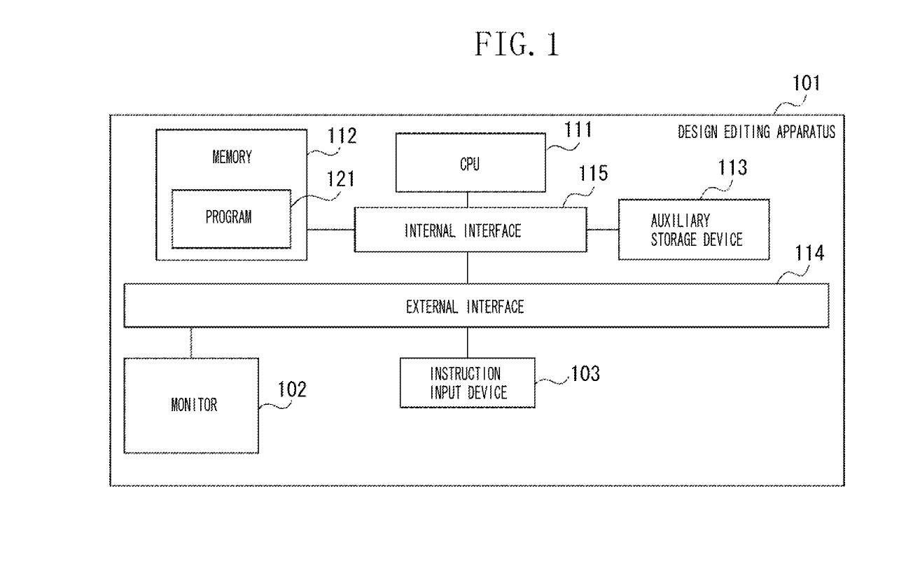

FIG. 1 is a block diagram illustrating a design editing apparatus 101 according to an exemplary embodiment of the present invention. The design editing apparatus 101 includes a monitor 102, an instruction input device 103 (e.g., a mouse or a keyboard), a central processing unit (CPU) 111, a memory 112, an auxiliary storage device 113 (e.g., a hard disk drive), an external interface 114, and an internal interface 115. The CPU 111, the memory 112, the auxiliary storage device 113, and the external interface 114 can communicate with each other via the internal interface 115. The monitor 102, the instruction input device 103, and the internal interface 115 can communicate with each other via the external interface 114. A program 121 to be executed by the CPU 111 can be loaded into the memory 112.

The design editing apparatus according to an exemplary embodiment can be a design editing apparatus integrated with a monitor and an instruction input device, or can be a computer configured to execute an image editing program and associated with an input device (e.g., a keyboard) and a monitor displaying an image.

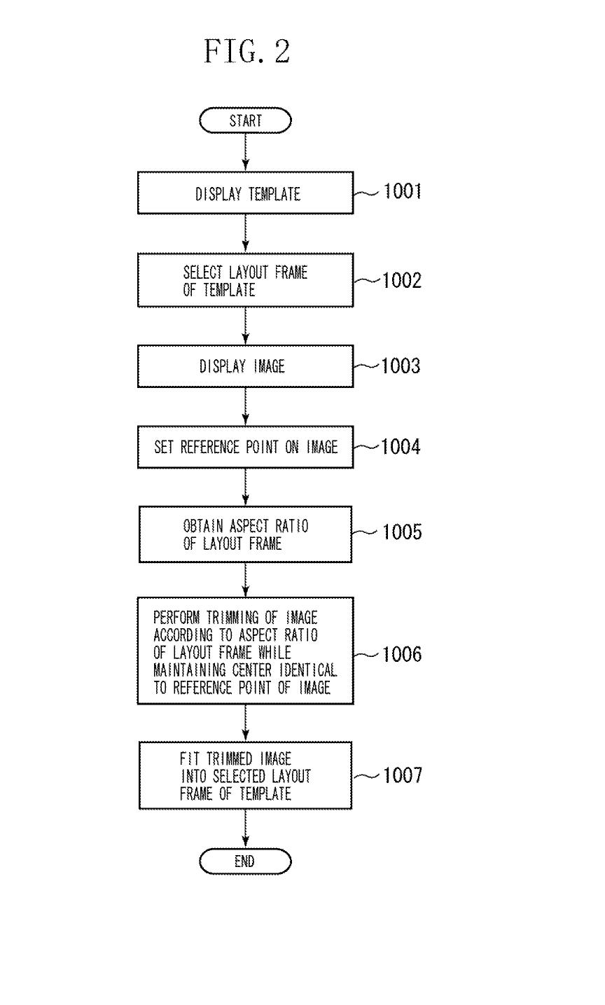

FIG. 2 is a flowchart illustrating an exemplary operation of the design editing apparatus 101 illustrated in FIG. 1 that can fit an image into a template. In the following description, a frame disposed on a template to which an image is fitted is referred to as “layout frame.”

The following is two fundamental types of images to be fitted.
(a) raster data
(b) vector data

Furthermore, the following is exemplary data formats.
(1) BMP
(2) JPEG
(3) TIFF
(4) PNG
(5) GIF
(6) SVG
(7) EMF
(8) WMF
(9) Other general image format
(10) Application program-dependent data format
   The above-described data formats (1) to (5) are dedicated to raster data, and the data formats (6) to (8) are applicable to both raster data and vector data. The data format (10) is unique to and dependent on each application program.

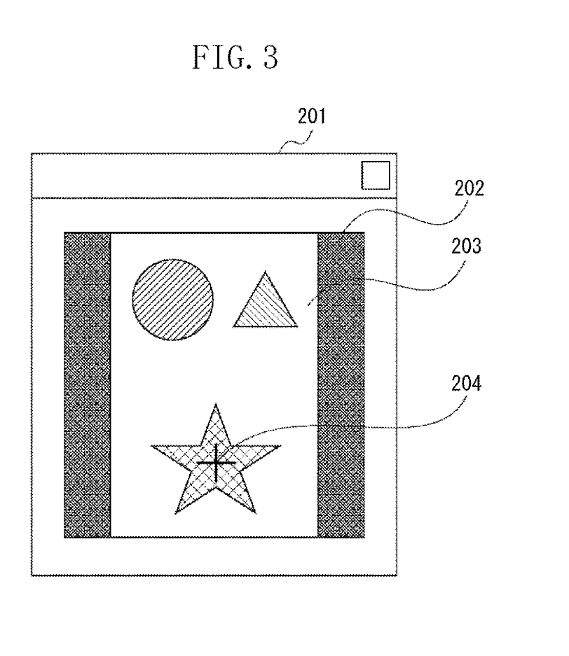

FIG. 3 illustrates a reference point setting screen that displays an image and enables a user to set a reference point. An image display screen 201 includes an image display area 202 in which an image 203 can be displayed. A trimming reference point 204 being presently set is displayed on the image 203. A marker (e.g., cross symbol) indicating the position of a trimming reference point is also referred to herein as a reference point marker.

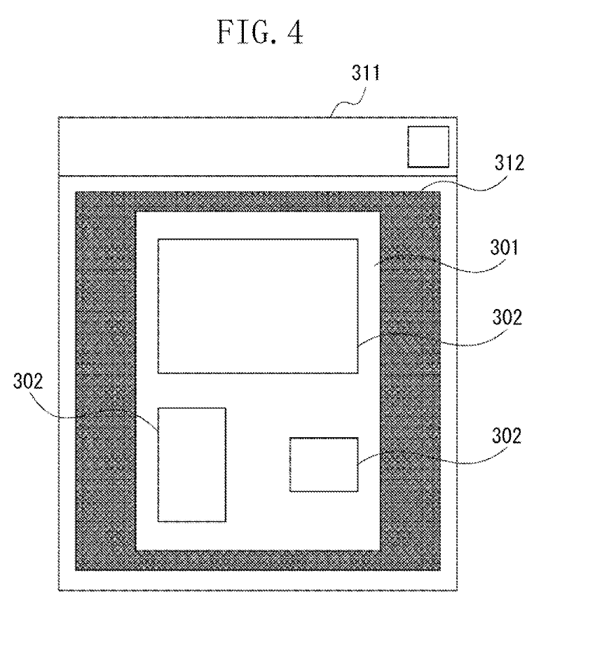

FIG. 4 illustrates a template 301 and a design editing screen 311 that can determine the basic layout of a design. The template 301 includes at least one layout frame 302 into which an image can be fitted. The position, size, and aspect ratio of each layout frame 302 can be arbitrarily determined. The design editing screen 311 includes a design display area 312 in which the template 301 can be displayed.

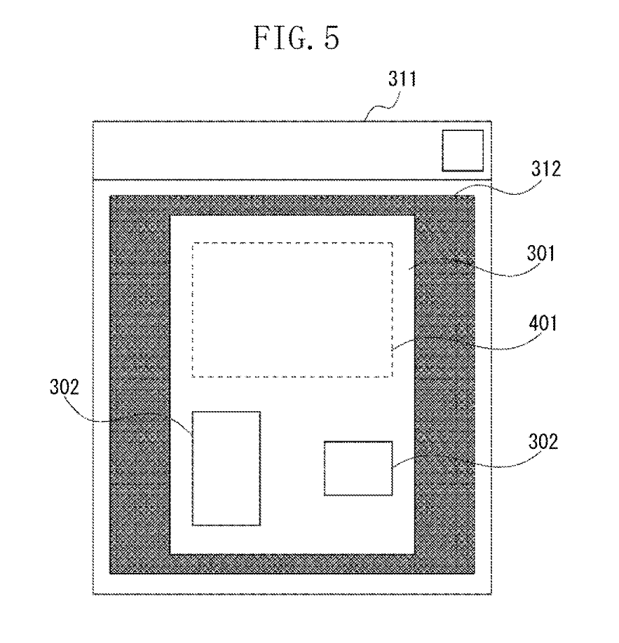

FIG. 5 illustrates an exemplary state of a layout frame 302 of the template 301 selected by a user to fit an image selected by a user. A dotted line 401 indicates a layout frame which is currently selected according to a user's operation.

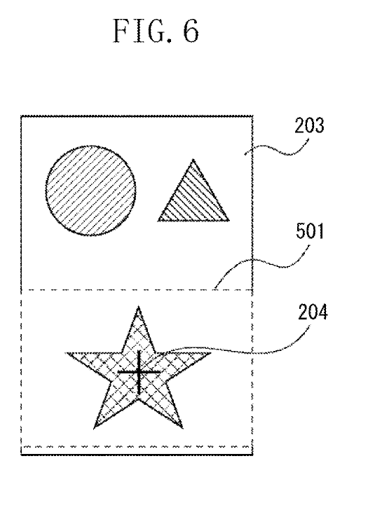

FIG. 6 illustrates a trimming area 501 determined according to an aspect ratio of the selected layout frame 401. The center of the trimming area 501 accords with the trimming reference point 204.

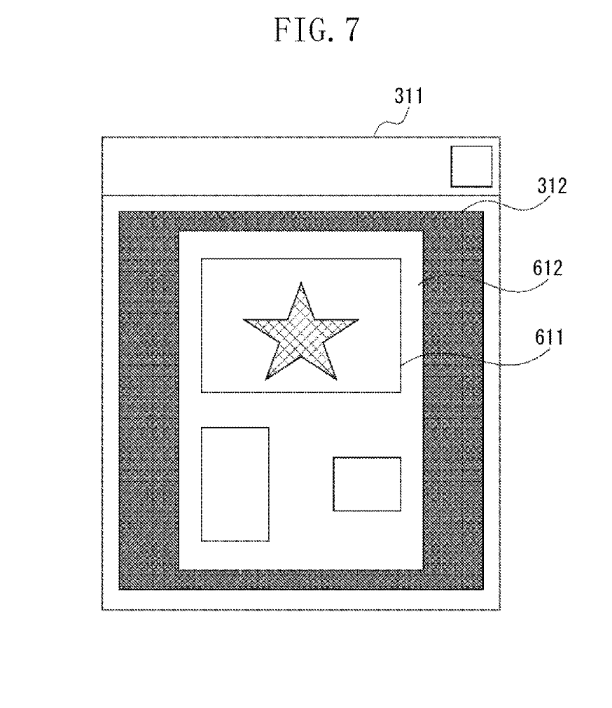

FIG. 7 illustrates the design display area 312 of the design editing screen 311 that displays an edited template 612 obtained by editing the template 301. More specifically, an image 611 is trimmed according to the trimming area 501 illustrated in FIG. 6 and the image 611 can be fitted into the selected layout frame 401 of the template 301 to generate the edited template 612.

An exemplary operation of the design editing apparatus 101 is described below according to the flowchart illustrated in FIG. 2 with reference to FIGS. 1 and 3 to 7. An exemplary embodiment described below uses the image illustrated in FIG. 3 and generates the design illustrated in FIG. 7.

When a user inputs a design initiation instruction via the instruction input device 103, the CPU 111 loads a program from the auxiliary storage device 113 into the memory 112, and executes design editing processing according to the loaded program 121. The CPU 111 loads or saves data from or to the auxiliary storage device 113 in response to an instruction received from the instruction input device 103. The CPU 111 causes the monitor 102 to display information.

In step 1001, the CPU 111 of the design editing apparatus 101 causes the monitor 102 to display the design editing screen 311. The CPU 111 loads the template 301 from the auxiliary storage device 113, and causes the monitor 102 to display the loaded template 301 on the design display area 312.

In step 1002, the CPU 111 selects the layout frame 401 into which an image is to be fitted (inserted) according to an instruction input via the instruction input device 103.

In step 1003, the CPU 111 causes the monitor 102 to display the image display screen 201, loads the image 203 from the auxiliary storage device 113, and causes the monitor 102 to display the image 203 in the image display area 202.

In step 1004, the CPU 111 sets (positions) the reference point 204 on the image 203 displayed on the image display screen 201 according to the instruction input via the instruction input device 103, and causes the monitor 102 to display the reference point 204 on the image 203.

In step 1005, the CPU 111 obtains an aspect ratio of the selected layout frame 401 of the template 301.

In step 1006, the CPU 111 determines the trimming area 501 having a center that corresponds with the reference point 204 positioned on the image 203. The trimming area 501 is an area maximized within the area of image 203 while maintaining the aspect ratio obtained in step 1005, without losing any part of the image. Then, the CPU 111 performs trimming processing on the image 203. In this case, in order to determine the trimming area 501 that can prevent any loss of an image in step 1006, if this area is enlarged or contracted and fitted into the layout frame 401, the image can be fitted into the entire area of the layout frame 401 without any edge region of the image that enters the inside of the layout frame 401.

In step 1007, the CPU 111 fits the trimmed image 611 into the selected layout frame 401 of the template 301, and displays the template 612 including the fitted image.

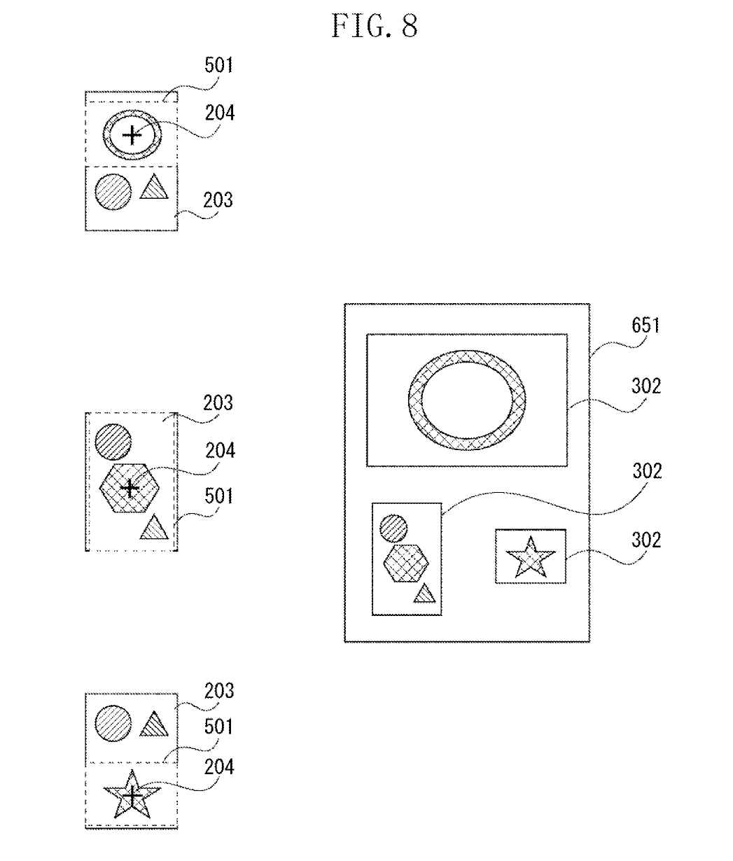

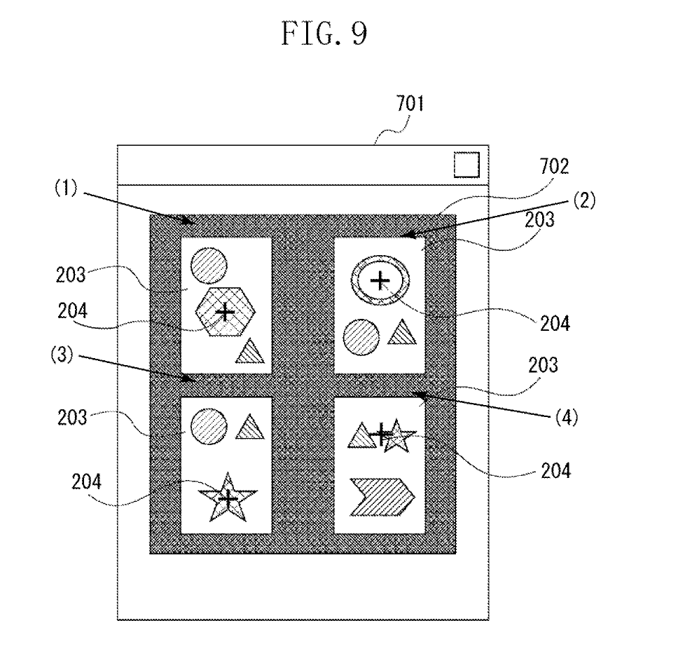

If a user is not required to select the layout frame 302 of the template 301 via the instruction input device 103, the above-described processing in steps 1001 and 1002 can be omitted. For example, as illustrated in FIG. 8, when the number of the images 203 is equal to the number of the layout frames 302, the CPU 111 can fit the images 203 into the layout frames 302 according to a predetermined order. FIG. 8 illustrates three images 203 and an exemplary template 651 including three layout frames 302. The CPU 111 can automatically perform the fitting processing with reference to the order of the images 203 and the order of the layout frames 302. The order of the layout frames 302 can be set beforehand to the template 651. An exemplary method for determining the order of images is described later with reference to FIG. 9.

The reference point setting screen illustrated in FIG. 3 is an example that displays only one image. However, as illustrated in FIG. 9, it is useful to display a list of images together with reference points. In FIG. 9, an image list display screen 701 includes an image list display area 702 that displays a list of a plurality of images 203 together with the reference points 204 of respective images 203. The reference points 204 can be set for all images 203 displayed on the image list display screen 701 (can be continuously set for each image).

The image list display area 702 can be displayed together with the template 651 on the monitor 102. The image displayed on the image list display area 702 is a candidate image to be fitted into a layout frame and can be loaded from the auxiliary storage device 113. The order of the images 203 illustrated in FIG. 8 can be determined according to the display order, as indicated by (1) to (4) in FIG. 9, on the image list display area 702. A user can operate the instruction input device 103 to change the order of images displayed on the image list display area 702. In this manner, the order in the processing for fitting images into the layout frames 302 can be changed according to a user's operation. However, this order can be determined according to other method.

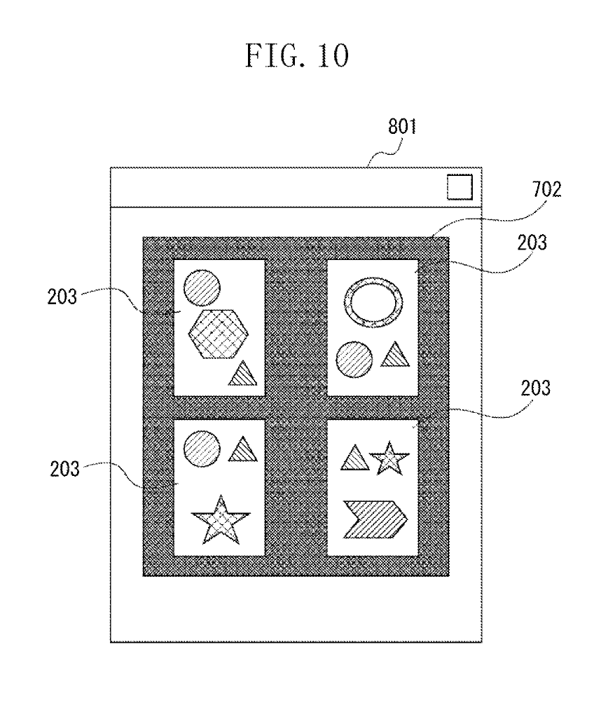

Furthermore, the instruction input device 103 enables a user to change the screen display settings. For example, as illustrated in FIG. 10, an image list display screen 801 including no reference points 204 can be displayed.

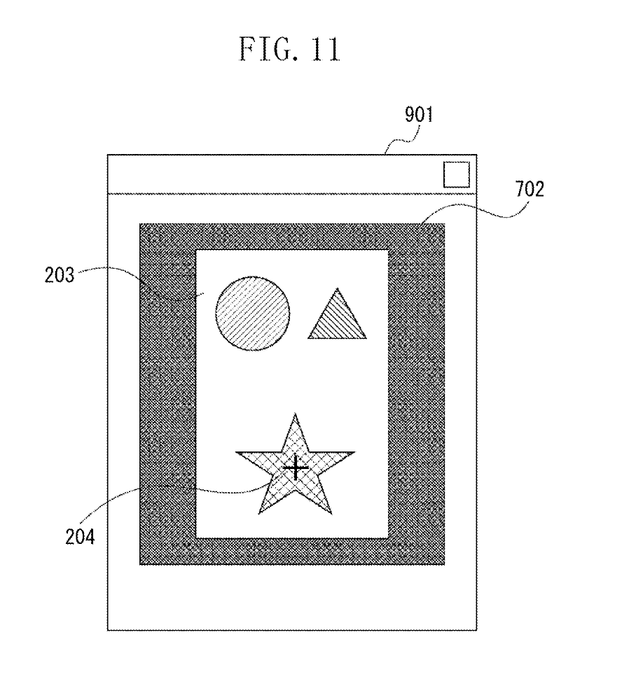

Furthermore, as illustrated in FIG. 11, the instruction input device 103 enables a user to display an enlarged image 203 in an image list display screen 901 by changing the screen display settings, so that a user can easily set the reference point 204.

According to the above-described embodiment, the CPU 111 displays an image loaded from the auxiliary storage device 113 on the image display screen 201 (the image display area 202) or on the image list display screen 701 and fits the image into the layout frame 302 of the template. However, the input source of an image (i.e., a source from which an image can be loaded) is not limited to the auxiliary storage device 113. For example, the CPU 111 can receive an image from other computer, a memory, a hard disk, or a digital camera via a network interface (not illustrated) or a USB interface (not illustrated) connected to the external interface 114.

As described above, an exemplary embodiment sets a reference point on an image to be fitted and determines a trimming area of the image according to an aspect ratio of a layout frame while maintaining the center identical to the reference point being set. Thus, compared to a conventional technique that sets a rectangular trimming area and cannot prevent an edge region of an image from entering inside a layout frame, the above-described exemplary embodiment can perform the trimming processing in such a manner that a trimmed image just fits the layout frame while preventing an edge region of the image from entering the layout frame.

The setting of a trimming reference point requires only designating an arbitrary point on an image. Therefore, the operation is simple compared to a conventional technique that requires a user to set a rectangular region designating upper/lower and right/left positions of a trimming area. Thus, an exemplary embodiment can reduce the amount of a work for displaying plural images and setting reference points to respective images, compared to a conventional method requiring a designation of a rectangular region.

The setting of a trimming reference point requires only displaying the position of a point on an image. Therefore, a display of plural images displayed together with reference points according to the above-described embodiment is also simple compared to a conventional display of a trimming area.

An exemplary design editing system may include a storage medium (a compact disk (CD), a digital versatile disk (DVD), etc) that supplies a design editing program to a user and a computer that installs the supplied design editing program and executes the installed program. Another exemplary design editing apparatus may be a computer that downloads a design editing program via a telecommunication circuit (network) and executes the downloaded program. Another exemplary design editing system may include a network server that executes an installed design editing program and enables other computer to access the server via a network and use the function of the server.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-330687 filed Dec. 07, 2006, which is hereby incorporated by reference herein in its entirety.

What is claimed is:

1. A method comprising:
setting a reference point on an image to be fitted into a layout frame;
performing trimming processing on the image according to the reference point being set on the image and an aspect ratio of the layout frame; and
fitting a trimmed image into the layout frame.

2. The method according to claim 1, further comprising:
displaying the image to be fitted into the layout frame on a display screen; and
enabling a user to set the reference point by receiving a user input and positioning a reference point marker within the display screen based on the user input, wherein the reference point is set based on a position of the reference point marker.

3. The method according to claim 1, wherein the trimming processing is performed based on a determination of a trimming area having a center that corresponds with the reference point set on the image to be fitted into the layout frame.

4. The method according to claim 1, further comprising setting the reference point that accords with a point designated via a setting screen that enables a user to set a reference point of an original image, which is different from a screen that displays the template.

5. The method according to claim 1, further comprising
displaying a list of a plurality of images as candidates to be fitted into the layout frame, and
displaying a reference point on an image included in the list.

6. The method according to claim 5, further comprising switching between display and non-display of the reference point for an image included in the list.

7. The method according to claim 5, further comprising changing a display size of an image included in the list.

8. The method according to claim 1, further comprising
selecting one of a plurality of layout frames according to a user's instruction, and
fitting the trimmed image into the selected layout frame.

9. The method according to claim 1, wherein the layout frame is included in a template.

10. An apparatus comprising:
a reference point setting unit configured to set a reference point on an image to be fitted into a layout frame;
a trimming unit configured to perform trimming processing on the image according to the reference point being set on the image and an aspect ratio of the layout frame; and
a layout unit configured to fit a trimmed image into the layout frame.

11. The apparatus according to claim 10, further comprising:
a display screen to display the image to be fitted into the layout frame,
wherein a reference point marker is positionable within the display screen based on a user input,
wherein the reference point is set based on a position of the reference point marker.

12. The apparatus according to claim 10, wherein the trimming processing is performed based on a determination of a trimming area having a center that corresponds with the reference point set on the image to be fitted into the layout frame.

13. The apparatus according to claim 10, wherein the reference point setting unit sets the reference point that accords with a point designated via a setting screen that enables a user to set a reference point of an original image, which is different from a screen that displays the template.

14. The apparatus according to claim 10, further comprising
an image list display unit configured to display a list of a plurality of images as candidates to be fitted into the layout frame, and
a reference point display unit configured to display a reference point on an image included in the list.

15. The apparatus according to claim 13, further comprising a reference point display switching unit configured to switch between display and non-display of the reference point for an image included in the list.

16. The apparatus according to claim 14, further comprising an image size changing unit configured to change a display size of an image included in the list.

17. The apparatus according to claim 10, further comprising a layout frame selection unit configured to select one of a plurality of layout frames according to a user's instruction, wherein the layout unit fits the trimmed image into the selected layout frame.

18. The apparatus according to claim 10, wherein the apparatus is a design editing apparatus.

19. The apparatus according to claim 10, wherein the layout frame is included in a template.

20. A storage medium storing instructions which, when executed by an apparatus, causes the apparatus to execute the method defined in claim 1.
